(19) United States
(12) Patent Application Publication
(10) Pub. No.: US 2010/0063316 A1
(43) Pub. Date: Mar. 11, 2010

(54) REACTIVE PHOSPHONATES

(75) Inventors: Patrick P.B. Notte, Wavre (BE); Jan H.J. Van Bree, Ottenburg (BE); Albert Devaux, Mont-Saint-Guibert (BE)

Correspondence Address: HUSCH BLACKWELL SANDERS LLP, 190 Carondelet Plaza, Suite 600, ST. LOUIS, MO, 63105, US

(73) Assignee: Thermphos Trading GmbH, Zug (CH)

(21) Appl. No.: 12/518,694

(22) PCT Filed: Dec. 11, 2007
(86) PCT No.: PCT/EP07/63685

§ 371 Date: Oct. 27, 2009

(30) Foreign Application Priority Data
Dec. 11, 2006 (EP) 06025515.5

(51) Int. Cl. C07F 9/02

(52) U.S. Cl. 562/11

(57) ABSTRACT

Novel reactive phosphonate compounds are disclosed corresponding to the structural formula set forth. The reactive moiety is preferably selected from the group of Cl, I, Br, HSO₄, NO₃, mixtures of Cl and I, CH₃SO₃ and p-toluene sulfonic acid whereas the hydrocarbon linking group between the nitrogen and the reactive moiety is most preferably a linear hydrocarbon chain having fro 3 to 12 carbon atoms. The novel phosphonates herein can be used in multiple established applications, such as detergency, water treatment, oil recovery, pharmaceutical intermediate and pharmaceutical products. The novel compounds are particularly useful for the “tailor” synthesis of optimized structural arrangements capable of meeting beneficial performance requirements.

This invention relates to a class of novel phosphonate compounds. In particular, novel reactive phosphonate compounds having the formula Y—X—N(W)(ZPO₃M₂) wherein the individual structural moieties have a specifically defined meaning as set forth hereinafter. The “reactive” moiety, Y, is preferably represented by Cl, I, Br, HSO₄, NO₃, CH₃SO₃ and p-toluene sulfonic acid, and mixtures thereof, whereas the hydrocarbon link, X, between the nitrogen and the reactive moiety is preferably a hydrocarbon chain having from 3 to 30 carbon atoms or [A-O]ₓ-A wherein A is a C₂-C₆ hydrocarbon chain and x is an integer of from 1-100. The novel phosphonates herein are particularly beneficial for “tailor” synthesizing novel phosphonate compounds for example for use in a multitude of applications such as dispersion, water-treatment, scale inhibition, sequestration, corrosion inhibition, pharmaceuticals and pharmaceutical intermediates, textiles, detergents, secondary oil recovery, paper industry, sugar and beer industry, fertilizers and micronutrients and metal treatment.

Phosphonate compounds broadly are well-known and have been used in multiple applications. The prior art is thus crowded and diverse. EP 0 401 833 discloses aminophosphonate-containing polymers and their use as dispersants for concentrated aqueous particulate slurries and as corrosion and scale inhibitors. The phosphonates contain ethylenically unsaturated comonomers and can be prepared by reacting the polymeric reactant with a phosphonate halohydrin or with a phosphonate epoxide.

U.S. Pat. No. 5,879,445 describes the use of compounds containing at least one phosphonic aminoalkylene group and at least one polyalkoxylated chain for fluidizing an aqueous suspension of mineral particles or hydraulic binder paste. WO 94/08913 divulges comparable technologies.

U.S. Pat. No. 4,330,487 describes a process of preparing N,N′-disubstituted methylene phosphonic acids by reacting α,ω-alkylene diamines with formaldehyde and phosphorous acid in aqueous medium in accordance with the Mannich reaction at a pH of generally less than 1. Zaitsev V. N. et al., Russian Chemical Bulletin, (1999), 48(12), 2315-2320, divulges modified silicas containing aminophosphonic acids covalently bonded onto the silica surface.

U.S. Pat. No. 4,260,738 describes starch ether derivatives containing aminophosphonic acid groups, namely either one or two anionic methylene phosphonic acid groups, bound to a cationic nitrogen. The starch derivative is said to exhibit cationic or anionic properties which (properties) may be increased by introducing selected groups together with the aminophosphonic acid reagent. The starch derivatives can be used beneficially as pigment retention aids in paper making processes. U.S. Pat. No. 4,297,299 pertains to novel N-(alkyl)-N-(2-haloethyl)-aminomethylene phosphonic acids exhibiting desirable pigment retention properties upon use in paper making processes.

U.S. Pat. No. 4,707,306 discloses alpha-aminomethylene phosphonate betaines and polymers prepared therewith. J. Mortier et al. disclose the synthesis of N-alkyl/aryl-alpha/beta-aminoalkylphosphonic acids from organodichloroboranes and alpha/beta-azidoalkylphosphonates via polyborophosphonates.

The prior art does provide a limited number of phosphonate compounds which are frequently marginally adapted and optimized for use within the context of an ever broadening range of known and novel applications.

It is a major object of this invention to provide novel phosphonate compounds eminently suitable and optimized for a large variety of applications. Another object of this invention aims at generating a range of novel reactive phosphonates suitable for “tailor” synthesizing phosphonate compounds, with high selectivity, which compounds can be used beneficially in established and additional, to current usages, applications.

The foregoing and other objects can now be met by a specifically defined class of reactive phosphonate compounds as defined in detail below.

The term “percent” or “%” as used throughout this application stands, unless defined differently, for “percent by weight” or “% by weight”. The terms “phosphonic acid” and “phosphonate” are also used interchangeably depending, of course, upon medium prevailing alkalinity/acidity conditions. The term “reactive” phosphonate is merely meant to emphasize the ease with which the claimed phosphonate compounds can be used for synthesizing other phosphonates.

Phosphonic acid compounds have now been discovered containing, in essence, a reactive moiety Y attached, by means of a hydrocarbon link, X, to an amino phosphonic acid moiety. In more detail, this invention concerns:

a reactive phosphonate compound having the formula:

Y—X—N(W)(ZPO₃M₂)

wherein Y is selected from: substituents the conjugated acid of which have a pKa equal to or smaller than 4.0;

X is selected from C₃-C₅₀ linear, branched, cyclic or aromatic hydrocarbon chain, optionally substituted by a C₁-C₁₂ linear, branched, cyclic, or aromatic group, (which chain and/or which group can be) optionally substituted by OH, COOH, F, OR′ and SR′ moieties, wherein R′ is a C₁-C₁₂ linear, branched, cyclic or aromatic hydrocarbon chain; and [A-O]ₓ-A wherein A is a C₂-C₉ linear, branched, cyclic or aromatic hydrocarbon chain and x is an integer from 1 to 200;

provided that when X is substituted by OH such moiety can be attached to any carbon atom other than the second carbon atom starting from Y;

Z is a C₁-C₆ alkylene chain;

M is selected from H and C₁-C₂₀ linear, branched, cyclic or aromatic hydrocarbon chains;

W is selected from H, ZPO₃M₂ and [V-N(K)]ₙK, wherein V is selected from: a C₂-C₅₀ linear, branched, cyclic or aromatic hydrocarbon chain, optionally substituted by C₁-C₁₂ linear, branched, cyclic or aromatic groups, (which chains and/or groups are) optionally substituted by OH, COOH, F, OR′ or SR′ moieties wherein R′ is a C₁-C₁₂ linear, branched, cyclic or aromatic hydrocarbon chain; and from [A-O]ₓ-A wherein A is a C₂-C₉ linear, branched, cyclic or aromatic hydrocarbon chain and x is an integer from 1 to 200; and

K is ZPO₃M₂ or H and n is an integer from 0 to 200;

wherein the following compound is excluded:

chloropropyl imino mono (methylene phosphonic acid.

In preferred executions, the pKa is equal to or smaller than 1.0 and X is a hydrocarbon having from 3 to 30 carbon atoms or [A-O]ₓ-A wherein A is a C₂-C₆ hydrocarbon chain and x is of from 1-100 and W is ZPO₃M₂.

The pKa value is a well known variable which can be expressed as follows:

pKa=−log₁₀Ka.

wherein Ka represents the thermodynamic equilibrium acidity constant. The pKa values of all acid substances are known from the literature or can, if this were needed, be determined conveniently. Values are listed, e. g., in the Handbook of Chemistry and Physics.

Y can preferably be selected from Cl, Br, I, HSO₄, NO₃, CH₃SO₃ and p-toluene sulfonate and mixtures thereof.

In the definition of X, R′, A and V the Cₓ-C_{y} linear or branched hydrocarbon chain is preferably a linear or branched alkane-diyl with a respective chain length. Cyclic hydrocarbon chain is preferably C₃-C₁₀-cycloalkane-diyl. Aromatic hydrocarbon chain is preferably C₆-C₁₂-arene-diyl. When the foregoing hydrocarbon chains are substituted, it is preferably with linear or branched alkyl of a respective chain length, C₃-C₁₀-cycloalkyl, or C₆-C₁₂-aryl. All these groups can be further substituted with the groups listed with the respective symbols.

More and particularly preferred chain lengths for alkane moieties are listed with the specific symbols. A cyclic moiety is more preferred a cyclohexane moiety, in case of cyclohexane-diyl in particular a cyclohexane-1,4-diyl moiety. An aromatic moiety is preferably phenylene or phenyl as the case may be, for phenylene 1,4-phenylene is particularly preferred.

The individual radicals in the phosphonate compound can, in a preferred manner, be beneficially selected from species as follows:

| Moiety | Preferred | Most Preferred |
|---|---|---|
| X | C₃-C₃₀ | C₃-C₁₂ |
| | [A-O]ₓ-A | [A-O]ₓ-A |
| V | C₂-C₃₀ | C₂-C₁₂ |
| | [A-O]ₓ-A | [A-O]ₓ-A |

wherein for both, X and V independently;

| A | C₂-C₆, | C₂-C₄; and |
|---|---|---|
| x | 1-100 | 1-100 |
| Z | C₁-C₃ | C₁ |
| M | H, C₁-C₆ | H, C₁-C₄ |
| n | 1-100 | 1-25 |

A phosphonate compound having an OH substituent attached to the second, starting from Y, carbon atom of X, in the event Y stands for halogen, is not a phosphonate in the meaning of the invention. Preferably, a reactive phosphonate, in the event Y stands for halogen, shall not carry an OH substituent attached to any one of the second, third or fourth, starting from Y, carbon atom of X.

In a preferred embodiment of the invention X is a C₃-C₃₀-hydrocarbon chain or [A-O]ₓ-A with the proviso that in the case of a C₃-hydrocarbon chain (W) is ZPO₃M₂.

In a further preferred embodiment of the invention X is C₃-C₃₀ or [A-O]ₓ-A and (W) is ZPO₃M₂.

In yet a further preferred embodiment of the invention X is [A-O]ₓ-A.

The preparation of the novel phosphonate compounds herein usually can require a sequence of individually well known measures routinely available in the domain of chemical synthesis. In one approach, the phosphonate compound can be prepared by phosphonating a chloroalkyl amine hydrochloride in a conventional manner by reaction, in aqueous medium, with phosphorous acid and formaldehyde, in acid medium, at a temperature generally in the range of from 50° C. to 140° C., preferably of from 90° C. to 120° C. The reaction partners are used in molar proportions consonant with the moiety ratios of the phosphonate product to be synthesized. In another approach, a reactive phosphonate can be synthesized by reacting, in aqueous medium having a pH of 6 or smaller, the corresponding alcohol e.g. HO-X-N(ZPO₃M₂)₂ with a suitable precursor for Y, e.g. hydrobromic, hydrochloric and/or hydroiodic acid, in obviously acid medium at a temperature in the range of from 100° C. to 200° C., preferably 110° C. to 150° C. A reactive phosphonate compound can also be prepared, as illustrated below, by a sequence of reactions involving, for example, the conversion of acrylonitrile:

CH₂═CH—CN(H)+HCl/H₂OCl—CH₂—CH₂≡CN (I)

(I)+H₂/catalyst→Cl—CH₂—CH₂—CH₂—NH₂ (C)

(C)+CH₂O/H₃PO₃/HCl→Cl—(CH₂)₃—N(CH₂PO₃H₂)₂ (D).

Alternatively, the phosphonate compounds herein can be synthesized differently as follows:

(H)+H⁺/H₂O→HO—CH₂—CH₂—CN (E)

(E)+H₂/catalyst→HO—(CH₂)₃—NH₂ (F)

(F)+HCl/H₂O→(C)→(D) or

(F)+CH₂O/H₃PO₃/HCl→HO—(CH₂)₃N(CH₂PO₃H₂)₂ (G)

(G)+HCl/H₂O→(D).

The acrylonitrile starting material can be substituted by other starting materials capable of yielding a reactive phosphonate. As an example such a phosphonate can be routinely synthesized starting from dichloro ethane and and alkali cyanide.

In yet another approach, this invention contemplates a process for the manufacture of the phosphonate compound of claim 1, wherein Y is I or Br, by ion-exchange of the chloro- phosphonate compound with an aqueous solution containing an inorganic, preferably an alkali metal, iodide or bromide salt at a temperature of from 10° C. to 100° C. wherein the ion exchange reaction medium has an acid pH equal to 6 or smaller, preferably in the range of from 1 to 4.

The pH measurements in the manufacturing arrangements are determined in the reaction medium at the reaction temperature.

Recovery of the reaction products is preferably carried out in a manner known per se to those skilled in the art. For example, the free phosphonic acids can be precipitated, e.g. by acidification of the reaction mixture, e.g. with concentrated hydrochloric acid, or by addition of a suitable solvent, e. g. ethanol, filtered of, washed and dried. Further purification can, e. g., be effected by recrystallisation or chromatographic methods.

The phosphonates of the invention are preferably used as reactive intermediates in the chemical and pharmaceutical industry, the textile industry, the oil industry, paper industry, sugar industry, beer industry, the agrochemical industry and in agriculture.

Preferred uses are as intermediates for the production of dispersants, water treatment agents, scale inhibitors, pharmaceuticals, detergents, secondary oil recovery agents, fertilisers and micronutrients (for plants).

The inventive phosphonates are illustrated by means of individual sample preparations, Examples I-VI, recited hereinafter.

I:

260.04 g of 3-Chloropropyl amine hydrochloride (2 moles) are dissolved in 250 ml of water and mixed with 328 g of phosphorous acid (4 moles) and 295.72 g of 37% aqueous HCl (3 moles). The mixture is heated under stirring to between 100° C. and 110° C. 361.02 g of 36.6% aqueous formaldehyde (4.4 moles) are added in 240 minutes while maintaining the temperature between 104° C. and 111° C. Heating at 110° C. is continued for an additional period of 60 minutes. Reaction mixture is then poured into a mixture of 1 liter of water and 200 ml ethanol at 50° C. Under cooling, a white precipitate is formed which is separated by filtration. 414 g (73.5%) of a white powder is obtained after drying. ³¹P NMR analysis of that white powder showed the presence of 93.5% of 3-chloro propyl imino bis(methylene phosphonic acid) (CPIBMPA); 2.7% of the corresponding azetidinium salt; 3.7% of hydroxy homologue of CPIBMPA and 0.1% of phosphorous acid.

II:

14.76 g (0.025 mole) of a 44.53% aqueous solution of 3-hydroxy propyl imino bis (methylene phosphonic acid) are placed in a high pressure glass tube and mixed with 9.86 g (0.10 mole) of 37% aqueous HCl. The tube is capped and the mixture heated under stirring between 120° C. and 125° C. for 7 hours. ³¹⁻P NMR analysis of the crude reaction product showed the presence of 67% of 3-chloro propyl imino bis(methylene phosphonic acid) with the balance being in majority the starting hydroxy product.

III:

14.76 g (0.025 mole) of a 44.53% aqueous solution of 3-hydroxy propyl imino bis (methylene phosphonic acid) are placed in a high pressure glass tube and mixed with 17.21 g (0.10 mole) of 47% aqueous HBr. The tube is capped and the mixture heated under stirring between 120° C. and 125° C. for 7 hours. ³¹-P NMR analysis of the crude reaction product showed the presence of 62% of 3-bromo propyl imino bis(methylene phosphonic acid) with the balance being in majority the starting hydroxy product.

IV:

14.76 g (0.025 mole) of a 44.53% aqueous solution of 3-hydroxy propyl imino bis (methylene phosphonic acid) are placed in a high pressure glass tube and mixed with 22.44 g (0.10 mole) of 57% aqueous HI. The tube is capped and the mixture heated under stirring between 120° C. and 125° C. for 7 hours. At room temperature a yellow precipitate is formed and separated from the aqueous phase by filtration. ³¹-P NMR analysis of the washed and dried precipitate indicated that it is 3-iodo propyl imino bis(methylene phosphonic acid) (IPBMPA). Yield is 70%.

V:

7.32 g (0.025 mole) of a 68.8% aqueous solution of 2-(2-imino bis[methylene phosphonic acid] ethoxy) ethanol are placed in a high pressure glass tube and mixed with 9.86 g (0.1 mole) of 37% aqueous HCl. The tube is capped and the mixture heated under stirring between 120° C. and 125 ° C. for 7 hours. ³¹-P NMR analysis of the crude reaction product showed the presence of 69% of 2-(2-imino bis[methylene phosphonic acid] ethoxy) chloro ethane with the balance being in majority the starting hydroxy product.

VI:

7.32 g (0.025 mole) of a 68.8% aqueous solution of 2-(2-imino bis[methylene phosphonic acid] ethoxy) ethanol are placed in a high pressure glass tube and mixed with 17.21 g (0.1 mole) of 47% aqueous HBr. The tube is capped and the mixture heated under stirring between 120° C. and 125 ° C. for 7 hours. ³¹-P NMR analysis of the crude reaction product showed the presence of 68% of 2-(2-imino bis[methylene phosphonic acid]ethoxy)bromo ethane with the balance being in majority the starting hydroxy product.

The reactivity of hydroiodic acid in relation to ether or thioether bonds is documented in the art; it routinely follows that the preparation of the iodo species, corresponding to the chloro/bromo species of Examples V-VI, requires the use of a halogen exchange of the reaction product with an inorganic iodide.

The testing data illustrate and clarify significant aspects of the claimed technology. I: shows the formation of the chloropropyl derivative, in a 73.5% yield, starting from the corresponding chloroamine. II:, III: and IV: respectively describe the preparation of the 3-chloro, 3-bromo and 3-iodo propyl derivatives starting from the corresponding alcohol. The yields are, considering the non-optimized reaction conditions, in the range of from 60% to 70% which is high keeping in mind that the non-reacted part (by-product) is predominantly represented by the starting alcohol which can, in turn, be recycled. V: and VI: pertain to the formation of chloro or bromo derivatives starting from the corresponding hydroxyl alkyl ether amine. The products were formed in yields of 68% to 69% whereby the unreacted starting material constitutes the majority of the by-products.

1. A reactive phosphonate compound having the formula:
Y—X—N(W)(ZPO₃M₂)
wherein Y is a substituent the conjugated acid of which has a pKa equal to or smaller than 4.0 selected from the group of Cl, I, Br, HSO₄, NO₃, CH₃SO₃ and p-toluene sulfonate and mixtures thereof;
X is selected from C₃-C₅₀ linear, branched, cyclic or aromatic hydrocarbon chain, optionally substituted by a C₁-C₁₂ linear, branched, cyclic, or aromatic group, (which chain and/or which group can be) optionally substituted by OH, COOH, F, OR′ and SR′ moieties, wherein R′ is a C₁-C₁₂ linear, branched, cyclic or aromatic hydrocarbon chain; and [A-O]ₓ-A wherein A is a C₂-C₉ linear, branched, cyclic or aromatic hydrocarbon chain and x is an integer from 1 to 200;
provided that when X is substituted by OH such moiety can be attached to any carbon atom other than the second carbon atom starting from Y;
Z is a C₁-C₆ alkylene chain;
M is selected from H and C₁-C₂₀ linear, branched, cyclic or aromatic hydrocarbon chains;
W is selected from H, ZPO₃M₂ and [V-N(K)]ₙK, wherein V is selected from: a C₂-C₅₀ linear, branched, cyclic or aromatic hydrocarbon chain, optionally substituted by C₁-C₁₂ linear, branched, cyclic or aromatic groups, (which chains and/or groups are) optionally substituted by OH, COOH, F, OR′ or SR′ moieties wherein R′ is a C₁-C₁₂ linear, branched, cyclic or aromatic hydrocarbon chain; and from [A-O]ₓ-A wherein A is a C₂-C₉ linear, branched, cyclic or aromatic hydrocarbon chain and x is an integer from 1 to 200; and
K is ZPO₃M₂ or H and n is an integer from 0 to 200;
wherein the following compound is excluded: chloropropyl imino mono (methylene phosphonic acid.

2. The phosphonate compound as claimed in claim 1 wherein the pKa is equal to or smaller than 1.0;

3. The phosphonate compound in as claimed in claim 1 wherein the individual moieties are selected as follows: X is C₃-C₃₀ or [A-O]ₓA; V is C₂-C₃₀ or [A-O]ₓ-A, wherein for both, X and V independently, A is C₂-C₆ and x is 1-100; Z is C₁-C₃; M is H or C₁-C₆ and n is 1-100.

4. The phosphonate compound as claimed in claim 1 wherein X is C₃-C₃₀ or [A-O]ₓ-A and (W) is ZPO₃M₂.

5. (canceled)

6. The phosphonate compound claimed in claim 1 wherein the individual moieties are selected as follows: X is C₃-C₁₂ or [A-O]ₓ-A; V is C₂-C₁₂ or [A-O]ₓ-A, wherein for both, X and V independently, A is C₂-C₄ and x is 1-100; Z is C₁; M is H, C₁-C₄ and n is 1-25.

7. (canceled)

8. The phosphonate compound claimed in claim 1 wherein the optional OH substituent is attached, in the event Y stands for halogen, to any carbon atoms, other than the second, third or fourth, starting from Y, carbon atoms of the group X.

9. A process for the manufacture of the phosphonate compound of claim 1 by reacting an amine of the formula halogen-X—NH₂, wherein halogen stands for Cl, Br or I and X has the meaning as defined in claim 1, in aqueous medium having a pH equal to or smaller than 6 with phosphorous acid and formaldehyde at a temperature in the range of from 50° C. to 140° C.

10. A process for the manufacture of the phosphonate compound in accordance with claim 1 by reacting a compound of the formula HO—X—N(ZPO₃M₂)₂, wherein X, Z and M have the meaning as defined in claim 1, in aqueous medium having an acid pH equal to or smaller than 6, with a hydrohalogenic acid selected from hydrochloric acid, hydrobromic acid and hydroiodic acid with the proviso that hydroiodic acid is not used in the event X contains ether or thio-ether bonds.

11. The process for the manufacture of the phosphonate compound in accordance with claim 10, wherein Y is iodide or bromide, by ion-exchange of the chloro compound with an aqueous solution containing an inorganic iodide or bromide salt at a temperature of from 10° C. to 100° C. wherein the ion-exchange medium has a pH of 6 or smaller.

12. A process for the production of dispersants, water treatment agents, scale inhibitors, pharmaceuticals, detergents, secondary oil recovery agents, fertilisers and micronutrients, comprising the step of employing a phosphonate compound as claimed in claim 1 as an intermediate.
